(19) United States
(12) Patent Application Publication
(10) Pub. No.: US 2023/0301314 A1
(43) Pub. Date: Sep. 28, 2023

(54) SMOKE INFUSER BOX FOR FOOD AND DRINKS

(71) Applicant: Eric Asongwe, Weatherford, OK (US)

(72) Inventor: Eric Asongwe, Weatherford, OK (US)

(21) Appl. No.: 17/703,163

(22) Filed: Mar. 24, 2022

(51) Int. Cl. A23B 4/044

(52) U.S. Cl. CPC A23B 4/044; A23V 2002/00

(57) ABSTRACT

The present invention relates to a food and beverages smoke infuser box that can add variety of natural smoky flavour to meats, seafood, cheese, nuts, desserts, beverages and cocktails drink in a very little time. The smoke infuser box has a smoke inlet port on the top of the lid of the box for infusing the smoke into the box containing cocktails and food. The smoke infuser box has a tray with vertically elongated handles at both ends for keeping beverages and food inside the box for smoking the cocktail and food. In an alternative embodiment, user can also directly place the cocktails and drinking glass directly in the smoke infuser box without needing the tray.

### FIELD OF THE INVENTION

The present invention relates to a food and beverages smoke infuser box that can add a variety of natural smoky flavor to meats, seafood, cheese, nuts, desserts, beverages and cocktail drink in a very little time.

### BACKGROUND OF THE INVENTION

Portable smoke infusers promise to solve a lot of these problems. They are small and comparatively inexpensive, can be used indoors, and work quickly to deliver a hit of smoke. Since they are portable they can be used table side to add a bit of dramatic flair to the meal—there is nothing like presenting your guests with a drink or plate of oysters that has a cloud of aromatic smoke rolling off of it. The smoking gun offers effortless operation with the facility of putting the wood chips in the smoking chamber, place the hose in a covered bowl or zip locked bag, turn it on then use a match or lighter to ignite the wood chips. Giving smoky flavour to food and beverages takes the meal to next level without changing its texture or temperature because it is cold smoke.

Several prior attempts to deal with such problems have been utilized as set forth below.

Chinese Patent Publication No. CN114027554A relates to a smoking set for a cocktail tobacco and the cocktail tobacco. The smoking set for the cocktail cigarette sequentially comprises a sucker part, a smoke mixing part and a smoke inlet part wherein the smoke inlet part comprises at least two smoke containing holes, and each smoke containing hole is a conical hole with the gradually reduced cross section size form the tail end to the head end; the smoke

United States Patent Application No. US20190230946A1 discloses a smoking appliance in the form of a smoker gun. The appliance includes a major body portion that releasably receives a barrel. The barrel provides an air flow passage that extends from an inlet smoking to an outlet opening. Mounted in the barrel is a combustion bowl having an opening through which smoke is delivered to the air flow passage. A motor and impeller driver thereby causes air to flow along the air flow passage.

Denmark Patent Publication No. DE2150486A1 discloses a smoke generator for smoking foodstuffs comprises; a flow generator, e.g. a fan, a heat generator, e.g. electrical element or gas flame, a heat exchanger especially constituted of the heating element, for transferring the heat to the flowing medium, a receptacle for the raw material, e.g. wood chips, a regulator for the temp, or heat supply; guide element for the flowing medium.

Russian Patent Publication No. RU65346U1 discloses a device for smoking food products has a housing with cylindrical side walls, a bottom and a lid. Inside the case with a gap from the bottom, a pallet is installed. A smoke generator chamber is formed between the pallet and the bottom of the body to accommodate the smoke generator, and a grate for the processed products is installed above the pallet with a gap. The device differs from the prototype in that lid is removable, and annular protrusion is made along its edge, designed to interact with the annular groove at the open end of the side wall of the housing and create a sealing contact.

The present invention discloses a food and beverage smoke infuser box that has a smoke inlet on the top cover instead of the side of the box to ensure that the smoke stream goes directly into the cocktail glass and the food plate. The smoke inlet has a rubber sheath around its port to prevent smoke escaping from the box and make it flexible to use different model of smoking guns with different size hoses.

### SUMMARY OF THE INVENTION

The present invention discloses a food and beverage smoke infuser box that has a smoke inlet port on the top cover of the box for infusing the smoke into the box containing cocktails and meals. The smoke infuser box has a tray with vertically elongated handles for lifting out the tray from the box. The tray is used for placing plates, bowls with different food items in the smoke infuser box but drinks and cocktail glasses can be placed directly inside the box without the need of the tray to avoid spills.

In an embodiment of the present invention, the smoke inlet port of the box has a rubber sheath around its port to prevent smoke escaping from the box and make it flexible to use different model of smoking guns.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 illustrates an exemplary embodiment of smoke infuser box in accordance with an embodiment of the present invention;

FIG. 2 illustrates an exemplary embodiment of the smoke infuser box with tray out of the box in accordance with an embodiment of the present invention;

FIG. 3 illustrates an exemplary embodiment of smoke infuser box with lid open in accordance with an embodiment of the present invention;

FIG. 4 illustrates an exemplary embodiment of the smoke infuser box with lid closed in accordance with an embodiment of the present invention;

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

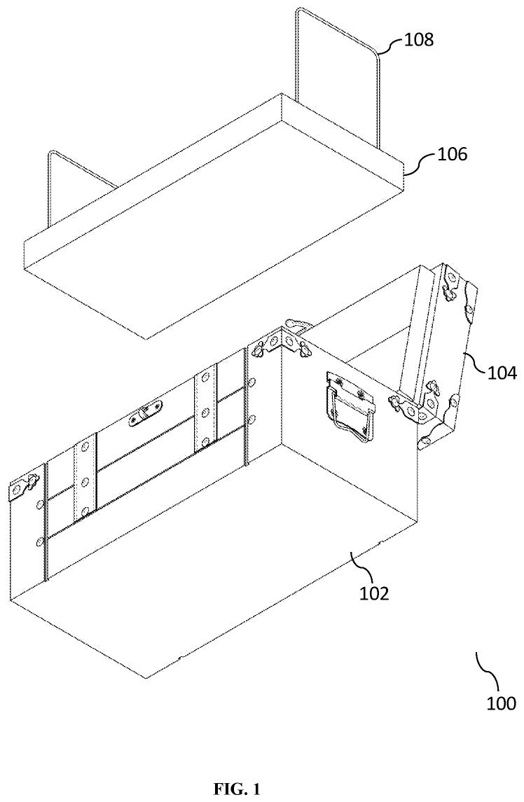

With reference now to the drawings, and in particular to FIG. 1 to FIG. 4 hereof, a smoke infuser box embodying the principles and concepts of the present invention is described.

Reference is made now to FIG. 1, illustrating an embodiment 100 of the smoke infuser box 102 comprising a tray 106 with elongated rectangular handles 108 at both the ends to lift the tray out of the box 102. The tray 106 is used to keep various dishes in the box 102 so that it can be infused with smoke generated by smoke gun through rubberized smoke inlet. However, drinks and cocktails glasses can be placed directly inside the box without the need of tray to avoid spills.

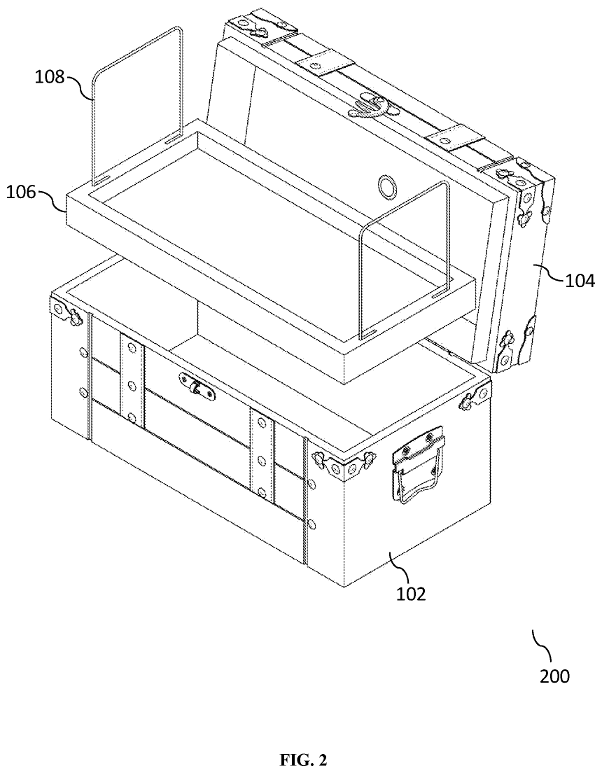

Reference is made now to FIG. 2, illustrating an embodiment 200 of the smoke infuser box 102 with tray 106 taken outside the box 102. The tray has rectangular base with vertically protruding sides to stop any liquid from spilling out of the tray 106. The tray is fitted with elongated handles for providing easy access to take out the tray.

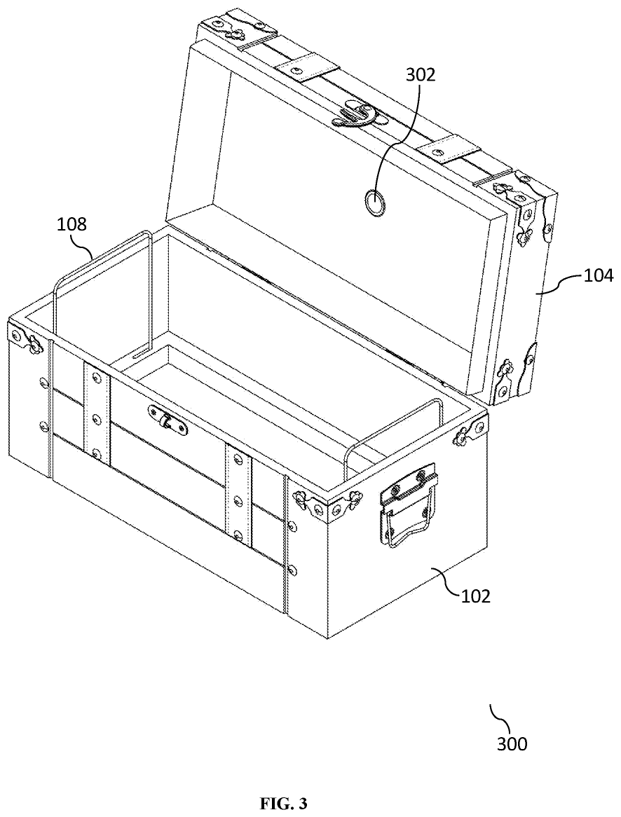

Reference is made now to FIG. 3, illustrating an embodiment 300 of the smoke infuser box 102 with its lid open. The smoke infuser box has a tray with vertically elongated handles for lifting out the tray from the box. The user can put an assortment of cocktails and meals on the tray 106 and place the tray 106 inside the smoke infuser box 102 which is then closed and connected with smoke gun for infusing smoke inside the box. The smoke infuser box has a smoke inlet port with a rubber sheath around its port to prevent smoke escaping from the box and make it flexible to use different model of smoking guns.

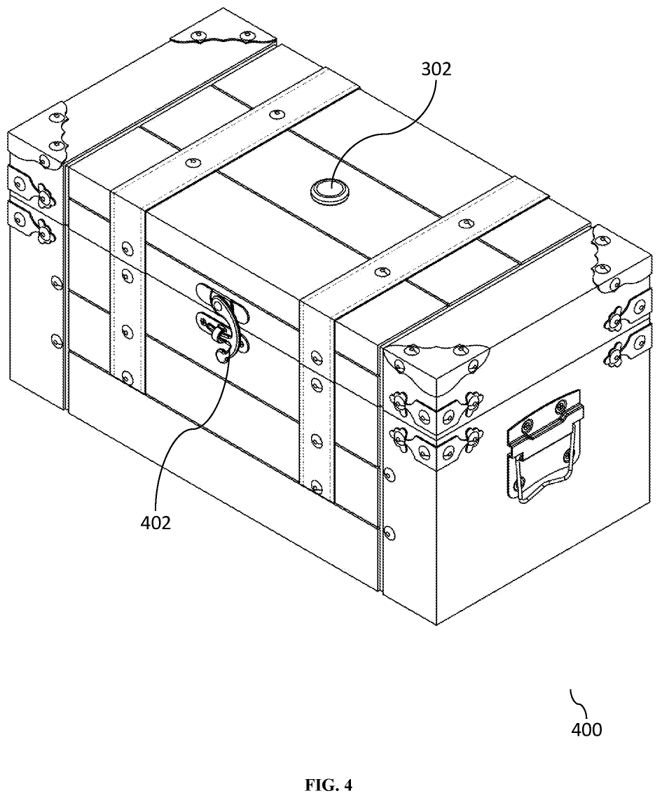

Reference is made now to FIG. 4, illustrating a perspective view embodiment 400 of the closed smoke infuser box 102 containing food and beverages for infusing with smoke. The smoke generated by smoke gun is transferred through pipe of the smoke gun which is connected to the smoke infuser box 102 by pushing the pipe inside the smoke inlet which is placed at the center of the lid of the box. The box has a hook 402 for closing the lid after the user has kept the cocktail and meal loaded tray inside the box.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular embodiment specifically contemplated, is intended to be practiced in the absence of any element which is not specifically disclosed herein.

1. The smoke infuser box comprising a box with a lid cover wherein the lid cover has a smoke inlet port on top for transferring the smoke from smoke gun through a pipe connected to the smoke gun.

2. The smoke infuser box according to claim 1, wherein the smoke inlet port of the smoke infuser box has a rubber sheath around its port to prevent smoke escaping from the box and make it flexible to use different model of smoking guns.

3. The smoke infuser box according to claim 1, wherein diffusing smoke from the upper side of the box ensures that the smoke goes directly into the cocktail glass and the food plate.

4. The smoke infuser box according to claim 1, wherein the smoke infuser box has a tray with vertically elongated handles for lifting out the tray from the box.

5. The smoke infuser box according to claim 1, wherein the tray of smoke infuser box is used to put different cocktails and meals on it which is then placed inside the smoke infuser box.
